(19) United States
(12) Patent Application Publication
(10) Pub. No.: US 2020/0130664 A1
(43) Pub. Date: Apr. 30, 2020

(54) HYDRAULIC BRAKING DEVICE

(71) Applicant: ADVICS CO., LTD., Kariya-shi, Aichi-ken (JP)

(72) Inventors: Fumitoshi KOYAMA, Kariya-shi, Aichi-ken (JP); Shin SASAKI, Okazaki-shi, Aichi-ken (JP); Yoshitake HISADA, Kariya-shi, Aichi-ken (JP); Tsuyoshi INO, Kariya-shi, Aichi-ken (JP)

(73) Assignee: ADVICS CO., LTD., Kariya-shi, Aichi-ken (JP)

(21) Appl. No.: 16/612,907

(22) PCT Filed: May 24, 2018
(86) PCT No.: PCT/JP2018/020058

§ 371 Date: Nov. 12, 2019

(30) Foreign Application Priority Data
May 25, 2017 (JP) 2017-103676

(51) Int. Cl. B60T 8/40; B60T 15/02

(52) U.S. Cl. CPC B60T 8/4068; B60T 15/028

(57) ABSTRACT

The present invention pertains to a hydraulic braking device which is provided with: a housing; a pump disposed within the housing; a motor that drives the pump; a plurality of solenoid valves disposed within the housing; WC ports that are provided to the housing and connected to wheel cylinders; and flow channels provided within the housing to connect between the pump, the solenoid valves and the WC ports, and in which the motor and the solenoid valves are controlled such that fluid pressure is generated in the wheel cylinders. The hydraulic braking device is further provided with a Helmholtz damper that is disposed within the housing to be connected to the flow channels and reduces pulses generated by the driving of the pump.

### TECHNICAL FIELD

The present invention relates to a hydraulic braking device.

### BACKGROUND ART

A hydraulic braking device is a device that includes a plurality of solenoid valves, flow channels, pumps and the like in a housing, and that controls the driving of the solenoid valves and the pumps to supply brake fluid to the wheel cylinders and adjust the fluid pressure of the wheel cylinder (hereinafter referred to as “wheel pressure”). The hydraulic braking device is provided with a damper mechanism in order to suppress pulsation due to driving of the pump. A hydraulic braking device including a damper mechanism is described in, for example, Japanese Unexamined Patent Application Publication No. 10-71942.

### CITATIONS LIST

### Patent Literature

Patent Literature 1: Japanese Unexamined Patent Application Publication No. 10-71942

### SUMMARY OF INVENTION

### Technical Problems

However, in the hydraulic braking device described above, the damper function is exhibited by an elastic member such as a rubber sphere, and it is difficult to attenuate high-frequency pulsations. In addition, in order to be applied to an existing (mass production type) hydraulic braking device, the size of the housing must be enlarged, which is problematic in terms of manufacturing cost.

The present invention has been contrived in view of such circumstances, and an object thereof is to provide a hydraulic braking device that can suppress high-frequency pulsation without enlarging the size of the housing.

### Solutions to Problems

A hydraulic braking device according to the present invention includes: a housing; a pump disposed in the housing; a motor for driving the pump; a plurality of solenoid valves disposed in the housing; a wheel cylinder port provided in the housing and connected to a wheel cylinder; and a flow channel provided in the housing to connect the pump, the plurality of solenoid valves, and the wheel cylinder port, the motor and the plurality of solenoid valves being controlled to generate fluid pressure in the wheel cylinder, the hydraulic braking device including: a Helmholtz type damper disposed in the housing and connected to the flow channel to reduce pulsation generated by driving of the pump using a principle of Helmholtz resonance.

### Advantageous Effects of Invention

The Helmholtz type damper can adjust the frequency to be reduced by designing the volume of the container portion and the opening of the neck portion according to the principle of Helmholtz resonance. By utilizing this characteristic and applying the Helmholtz type damper to the hydraulic braking device, it is possible to provide a damper mechanism that reduces high-frequency pulsations in a small space in the housing. That is, according to the present invention, high-frequency pulsation can be suppressed without increasing the size of the housing.

### BRIEF DESCRIPTION OF DRAWINGS

FIG. 1 is a configuration view of a brake device including an actuator according to a first embodiment.

FIG. 2 is a conceptual view of a damper according to the first embodiment.

FIG. 3 is a conceptual view of the damper according to the first embodiment.

FIG. 4 is an explanatory view of a Helmholtz type damper.

FIG. 5 is a conceptual view (front view) of the actuator according to the first embodiment.

FIG. 6 is a conceptual view (left side view) of the actuator according to the first embodiment.

FIG. 7 is a conceptual view (front view) on a first piping system side of the actuator according to the first embodiment.

FIG. 8 is a conceptual view of an orifice plate according to a second embodiment.

FIG. 9 is a conceptual view (front view) of a neck portion according to the second embodiment.

FIG. 10 is a conceptual view (front view) showing a modified example of the neck portion according to the second embodiment.

### DESCRIPTION OF EMBODIMENTS

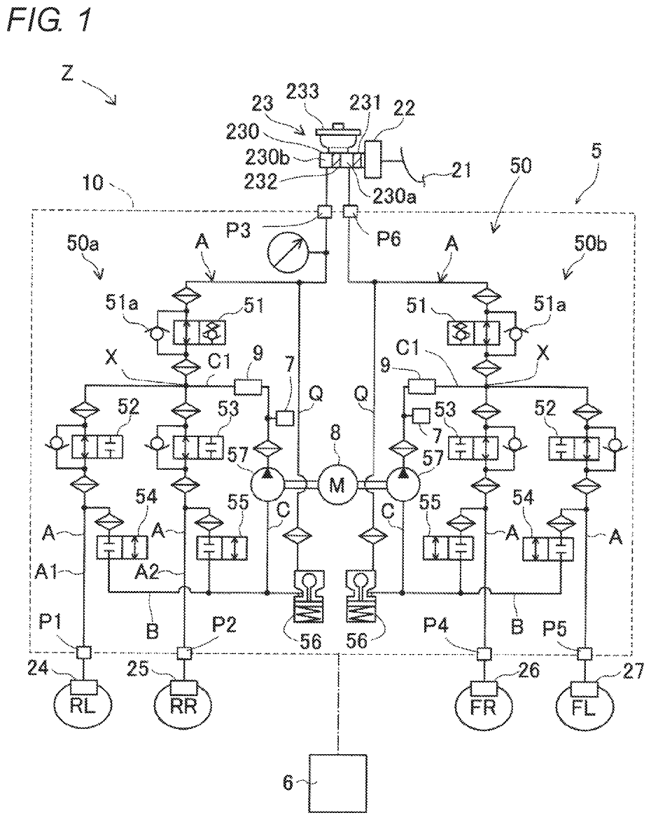

Hereinafter, embodiments of the present invention will be described based on the drawings. Each figure used for the description is a conceptual view, and the shape of each portion is not necessarily exact in some cases. As shown in FIG. 1, a hydraulic braking device according to a first embodiment includes an actuator 5 and a brake ECU 6. The actuator 5 is incorporated in a brake device Z of a vehicle. First, the entire brake device Z including the actuator 5 will be briefly described. A cylinder mechanism 23 includes a master cylinder 230, master pistons 231 and 232, and a master reservoir 233. The master pistons 231 and 232 are slidably disposed in the master cylinder 230. The master pistons 231 and 232 partition the inside of the master cylinder 230 into a first master chamber 230a and a second master chamber 230b. The master reservoir 233 is a reservoir tank including a flow channel communicating with the first master chamber 230a and the second master chamber 230b. The master reservoir 233 and each of the master chamber 230a and 230b are communicated/shut off in accordance with the movement of the master pistons 231 and 232.

A wheel cylinder 24 is disposed on a wheel RL (left rear wheel). A wheel cylinder 25 is disposed on a wheel RR (right rear wheel). A wheel cylinder 26 is disposed on a wheel FL (left front wheel). A wheel cylinder 27 is disposed on a wheel FR (right front wheel). The master cylinder 230 and the wheel cylinders 24 to 27 are connected through the actuator 5. The wheel cylinders 24 to 27 drive friction brakes (not shown) including brake pads and the like, and apply braking force to the wheels RL to FR.

Therefore, when the driver depresses a brake operation member 21, the depressing force is boosted by a booster device 22, and the master pistons 231 and 232 in the master cylinder 230 are pressed. Thus, a master cylinder pressure (hereinafter referred to as master pressure) of the same pressure is generated in the first master chamber 230a and the second master chamber 230b. The master pressure is transmitted to the wheel cylinders 24 to 27 through the actuator 5.

The actuator 5 is a device that adjusts the fluid pressure (hereinafter referred to as wheel pressure) of the wheel cylinders 24 to 27 in accordance with an instruction from a brake ECU 6, which is a control unit. Specifically, as shown in FIG. 1, the actuator 5 includes a housing 10, a hydraulic circuit 50, a Helmholtz type damper (hereinafter simply referred to as “damper”) 7, a motor 8, a check valve 9. The housing 10 is a rectangular parallelepiped metal block, and as will be described later, a flow channel and an accommodating portion for various components are formed inside by cutting or the like. The hydraulic circuit 50 is disposed and formed in the housing 10 and includes a first piping system 50a and a second piping system 50b. The first piping system 50a is a system that controls the fluid pressure (wheel pressure) applied to the wheels RL and RR. The second piping system 50b is a system that controls the fluid pressure (wheel pressure) applied to the wheels FL and FR. Since the basic configurations of the first piping system 50a and the second piping system 50b are the same, the first piping system 50a will be described below, and the description of the second piping system 50b will be omitted.

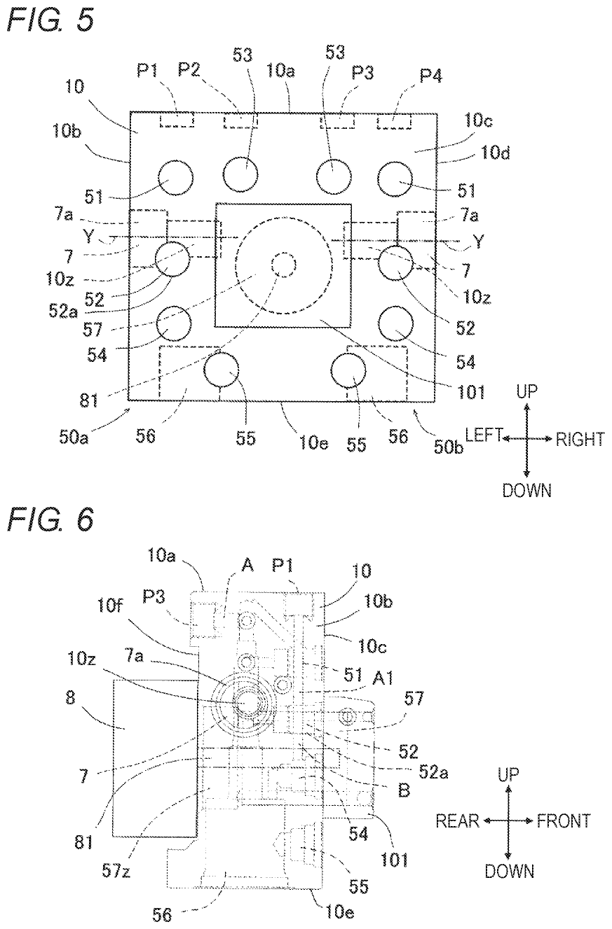

The first piping system 50a includes a main flow channel A, a differential pressure control valve 51, pressure increasing valves 52 and 53, a pressure decreasing flow channel B, pressure decreasing valves 54 and 55, a pressure regulating reservoir 56, a reflux flow channel C, a pump 57, an auxiliary flow channel Q, WC ports (corresponding to “wheel cylinder ports”) P1 and P2, and an MC port (corresponding to “master cylinder port”) P3. The WC ports P1 and P2 are provided on a first surface (here, upper surface in a vehicle installed state) 10a of the housing 10 (see FIG. 5). The WC port P1 is a port connected to the wheel cylinder 24, and the WC port P2 is a port connected to the wheel cylinder 25. The MC port P3 is provided on a surface different from the first surface 10a of the housing 10 (here, a sixth surface 10f described later) and is a port connected to the master cylinder 230. The second piping system 50b includes WC ports P4 and P5 and an MC port P6, as in the first piping system 50a.

The main flow channel A is a portion formed in the housing 10 of the flow channel connecting the master cylinder 230 and the wheel cylinders 24 and 25. That is, the main flow channel A is a flow channel that connects the WC ports P1, P2 and the MC port P5. The differential pressure control valve 51 is a solenoid valve disposed in a portion between a connecting portion X (described later) and the MC port P3 in the main flow channel A. The differential pressure control valve 51 is a valve that controls the main flow channel A to a communication state (no throttling state) and a differential pressure state (throttling state). Specifically, the differential pressure control valve 51 is a solenoid valve configured such that the differential pressure between the fluid pressure at the portion on the master cylinder 230 than itself in the main flow channel A and the fluid pressure at the portion on the wheel cylinders 24 and 25 side than itself in the main flow channel A can be controlled. In other words, the differential pressure control valve 51 controls the differential pressure between its upstream side and downstream side in accordance with an instruction from the brake ECU 6. The differential pressure control valve 51 is in a communication state in a non-energized state, and is controlled to be in a communication state in normal brake control excluding pressurization control (pressure increase assist), automatic braking, and skid prevention control. The differential pressure control valve 51 is set so that the differential pressure on both sides increases as the applied control current increases.

When the differential pressure control valve 51 is in the differential pressure state, the brake fluid (fluid) is permitted to flow from the wheel cylinders 24, 25 side toward the master cylinder 230 side when the fluid pressure on the wheel cylinders 24 and 25 side becomes a predetermined pressure higher than the fluid pressure on the master cylinder 230 side. The predetermined pressure is determined by the differential pressure set by the control current. Therefore, when the differential pressure control valve 51 is in a differential pressure state, both sides of the main flow channel A are maintained in a state where the fluid pressure on the wheel cylinders 24 and 25 side does not become higher than the fluid pressure on the master cylinder 230 side by greater than or equal to a predetermined pressure. That is, the differential pressure control valve 51 can realize a desired differential pressure state on both sides of the main flow channel A. Furthermore, a check valve 51a is installed with respect to the differential pressure control valve 51. The main flow channel A is branched into two flow channels A1 and A2 at a connecting portion X located on the downstream side of the differential pressure control valve 51 so as to correspond to the wheel cylinders 24 and 25. The connecting portion X can be said to be a portion where the main flow channel A on the downstream side of the differential pressure control valve 51 branches.

The pressure increasing valves 52 and 53 are solenoid valves that are opened and closed in accordance with an instruction from the brake ECU 6, and are normally open valves that are in an open state (communication state) in a non-energized state. The pressure increasing valve 52 is disposed in the flow channel A1, and the pressure increasing valve 53 is disposed in the flow channel A2. That is, the pressure increasing valves 52 and 53 are solenoid valves arranged at a portion between the connecting portion X and the WC ports P1 and P2 in the main flow channel A. The pressure increasing valves 52 and 53 are energized and are in a closed state mainly at the time of the pressure decreasing control, thus shutting off the master cylinder 230 and the wheel cylinders 24 and 25. The pressure decreasing flow channel B is a flow channel that connects the WC ports P1 and P2 and the pressure regulating reservoir 56. The pressure decreasing flow channel B connects a portion between the pressure increasing valve 52 and the wheel cylinder 24 in the flow channel A1 and the pressure regulating reservoir 56, and connects a portion between the pressure increasing valve 53 and the wheel cylinder 25 in the flow channel A2 and the pressure regulating reservoir 56. The pressure decreasing flow channel B uses a part of the main flow channel A.

The pressure decreasing valves 54 and 55 are solenoid valves that are opened and closed in accordance with an instruction from the brake ECU 6, and are normally closed valves that are in a closed state (shut off state) in a non-energized state. The pressure decreasing valve 54 is disposed in the pressure decreasing flow channel B on the wheel cylinder 24 side. The wheel cylinder 24 and the pressure regulating reservoir 56 are communicated/shut off according to the opening/closing of the pressure decreasing valve 54. The pressure decreasing valve 55 is disposed in the pressure decreasing flow channel B on the wheel cylinder 25 side. The wheel cylinder 25 and the pressure regulating reservoir 56 are communicated/shut off according to the opening/closing of the pressure decreasing valve 55. The pressure decreasing valves 54 and 55 are energized and opened mainly at the time of pressure decreasing control, and communicate the wheel cylinders 24 and 25 and the pressure regulating reservoir 56 through the pressure decreasing flow channel B. The pressure regulating reservoir 56 is a reservoir including a cylinder, a piston, and a biasing member.

The reflux flow channel C is a flow channel that connects the pressure decreasing flow channel B (or the pressure regulating reservoir 56) and the connecting portion X. The connecting portion X is a portion between the differential pressure control valve 51 and the pressure increasing valves 52 and 53 in the main flow channel A, and is a connecting portion between the main flow channel A and the reflux flow channel C. The connecting portion X can also be said as a portion (region) between the differential pressure control valve 51 and the pressure increasing valve 52 in the main flow channel A. In terms of circuit representation, in the hydraulic circuit diagram (FIG. 1), the main flow channel A branches off at the connecting portion X represented by a dot, and the main flow channel A and the discharge flow channel C1 are connected.

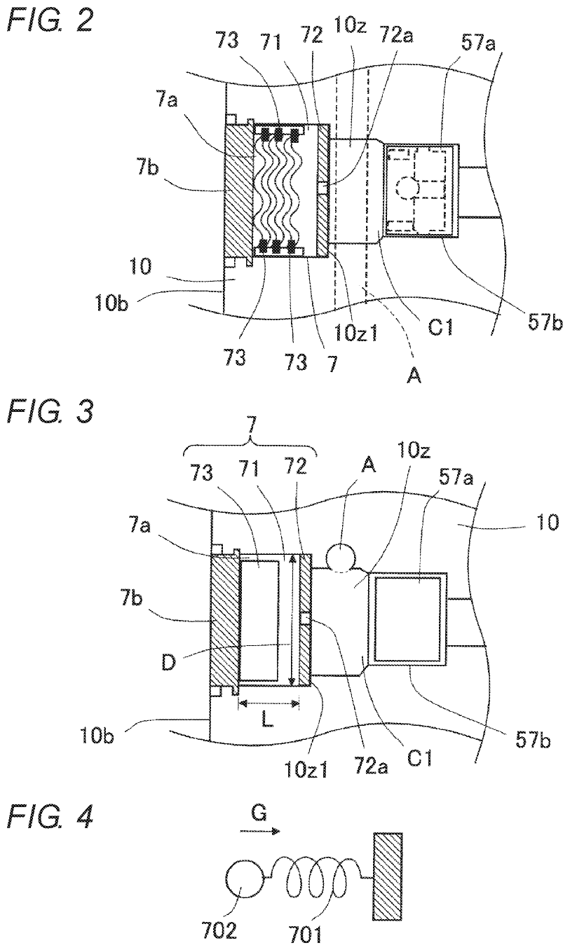

The pump 57 is provided in the reflux flow channel C. The pump 57 is a gear pump driven by the motor 8, and is a gear pump configured by arranging a gear (not shown) together with the motor 8 at the center portion of the housing 10. The pump 57 includes a discharge valve 57a (see FIG. 2), a suction valve (not shown), a gear, and the like. The pump 57 causes the brake fluid to flow from the pressure regulating reservoir 56 to the master cylinder 230 side or the wheel cylinders 24 and 25 side through the reflux flow channel C. The reflux flow channel C includes a discharge flow channel C1 that connects the discharge valve 57a of the pump 57 and the connecting portion X on the main flow channel A. The discharge flow channel C1 is a flow channel on the downstream side of the pump 57 in the reflux flow channel C. The motor 8 is energized through a relay (not shown) and is driven according to an instruction from the brake ECU 6. The motor 8 can be said to be a pump driving means. The check valve 9 is disposed in the discharge flow channel C1, and permits the brake fluid to flow from the pump 57 to the main flow channel A and prohibits the brake fluid to flow from the main flow channel A to the pump 57. An auxiliary flow channel Q is a flow channel that connecting the pressure regulating reservoir 56 and a portion on the upstream side (or master cylinder 230) of the differential pressure control valve 51 in the main flow channel A.

The brake fluid of the master cylinder 230 is discharged to the connecting portion X through the auxiliary flow channel Q, the pressure regulating reservoir 56, and the like by the driving of the pump 57. Thus, for example, at the time of a vehicle motion control such as automatic braking or skid prevention control, the target wheel pressure is increased. The actuator 5 of the first embodiment functions as an antilock brake system (ABS) or a skid prevention device (ESC) by the control of the brake ECU 6. The brake ECU 6 is an electronic control unit including a CPU, a memory, and the like. The brake ECU 6 is connected to the actuator 5 and controls the motor 8 (pump 57) and the plurality of solenoid valves 51 to 55.

Thus, the actuator 5 includes the housing 10, the pump 57 disposed in the housing 10, the motor 8 for driving the pump 57, the plurality of solenoid valves 51 to 55 disposed in the housing 10, the WC ports P1, P2 (P4, P5) disposed in the housing 10 and connected to the wheel cylinders 24, 25 (26, 27), the flow channels A to C disposed in the housing 10 to connect the pump 57, the plurality of solenoid valves 51 to 55 and the WC ports P1, P2 (P4, P5), the MC port P3 (P6) provided in the housing 10 and connected to the master cylinder 230, and the pressure regulating reservoir 56 disposed in the housing 10, where the motor 8 and the plurality of solenoid valves 51 to 55 are controlled by the brake ECU 6 to generate fluid pressure in the wheel cylinders 24 and 25 (26 and 27). The flow channels of the actuator 5 include the main flow channel A connecting the WC ports P1, P2 (P4, P5) and the MC port P3 (P6), the pressure decreasing flow channel B connecting the WC port P1, P2 (P4, P5) and the pressure regulating reservoir 56, and the discharge flow channel C1 connecting the discharge valve 57a of the pump 57 and the connecting portion X on the main flow channel A. Furthermore, the plurality of solenoid valves of the actuator 5 include the differential pressure control valve 51 disposed at a portion between the connecting portion X and the MC port P3 (P6) in the main flow channel A, the pressure increasing valves 52, 53 disposed at a portion between the connecting portion X and the WC ports P1, P2 (P4, P5) in the main flow channel A, and the pressure decreasing valves 54, 55 disposed in the pressure decreasing flow channel B.

### (Damper)

The damper 7 is a Helmholtz type damper that is connected to the flow channel of the first piping system 50a and reduces pulsation generated by the driving of the pump 57 using the principle of Helmholtz resonance. The damper 7 is connected to a portion between the differential pressure control valve 51 and the pressure increasing valves 52, 53 in the main flow channel A or the discharge flow channel C1 (discharge flow channel C1 in FIG. 1). The damper 7 is connected to a portion between the check valve 9 and the discharge valve 57a in the discharge flow channel C1. As shown in FIGS. 2 and 3, the damper 7 includes a volume portion 71, a neck portion 72, and a plurality of metal diaphragms 73.

The volume portion 71 is a portion that forms an internal space (volume) of the damper 7 in the housing 10, and is formed to a hollow circular column shape. The volume portion 71 can be said to be a damper chamber or a container. Specifically, the volume portion 71 is partitioned by a damper hole 7a provided in the housing 10, a lid 7b that closes the opening of the damper hole 7a, and the neck portion 72 disposed in the damper hole 7a. The lid 7b is fixed (e.g., press-fitted and fixed) to the open end of the damper hole 7a. The housing 10 is provided with a hole 10z for arranging the discharge valve 57a of the pump 57 in the housing 10. The damper hole 7a is a portion on the surface side of the housing 10 of the hole 10z, and is formed to have a larger diameter than a portion in which the discharge valve 57a is accommodated in the hole 10z. In the hole 10z, a step 10z1 is formed at the boundary between the damper hole 7a and the other portions. The hole 10z includes the damper hole 7a in which the damper 7 is disposed, the accommodating portion 57b in which the discharge valve 57a is accommodated, and the discharge flow channel C1.

The neck portion 72 is a portion that is connected to the volume portion 71 and functions as an orifice. The neck portion 72 can also be said to be an orifice hole forming portion. Specifically, the neck portion 72 is a portion disposed between the volume portion 71 and the discharge flow channel C1 (discharge valve 57a), and is a portion that forms a flow channel, that is, an orifice hole 72a having a flow channel cross-sectional area smaller than a cross-sectional area (can also be said as flow channel cross-sectional area or axis orthogonal cross-sectional area) of the damper hole 7a. The neck portion 72 of the first embodiment is configured by an orifice plate (72) including the orifice hole 72a. The neck portion 72 is an orifice plate disposed in the damper hole 7a. The outer peripheral surface of the orifice plate configuring the neck portion 72 and the wall surface of the damper hole 7a are brought into contact (sealed) over the entire periphery. In the first embodiment, the orifice hole 72a is formed at the center portion of the neck portion 72 (orifice plate). The neck portion 72 is fixed to an end on the step 10z1 side of the damper hole 7a.

The diaphragm 73 is a metal damper in which gas is sealed as a pulsation reducing mechanism, and is disposed in the volume portion 71. The diaphragm 73 of the first embodiment is formed to a wave shape. In the first embodiment, a plurality of diaphragms 73 are arranged in the volume portion 71. Thus, the damper 7 is disposed in the damper hole 7a provided in the housing 10.

Here, the principle of the Helmholtz type damper (damper 7) will be described. The pulsation reduction center frequency f₀ of the damper 7 is represented by f₀=(C/2π)×(A/(L₀×V))^{1/2}. C is the sound speed of the brake fluid in the volume portion 71, A is the flow channel cross-sectional area of the neck portion 72 (opening area of the orifice hole 72a), L₀ is the flow channel length of the neck portion 72 (axial lengths of the orifice hole 72a), and V is the volume of the volume portion 71. Furthermore, as shown in FIG. 3, assuming the inner diameter of the volume portion 71 (diameter of the damper hole 7a) is D and the depth (length) of the volume portion 71 is L, the volume V can be expressed as V=π×(D/2)²×L.

According to Helmholtz's theory, the brake fluid (fluid) in the neck portion 72 is assumed to be a piston of mass M (hereinafter referred to as “virtual piston”). The density of the virtual piston is the same as the density p of the brake fluid, and the cross-sectional area and length of the virtual piston are the same as the flow channel cross-sectional area and the axial length of the neck portion 72. Therefore, the mass M is expressed as M=ρ×L₀×A. On the other hand, the brake fluid in the volume portion 71 is assumed as an oil spring having a spring constant K. Therefore, the damper 7 is modeled as a spring 701 of one degree of freedom without attenuation and a mass point 702, as shown in FIG. 4. An arrow Gin FIG. 4 represents the displacement of the mass point 702. Assuming the displacement of the mass point 702 is x, the equation of motion of the above model is expressed as M×(d²x/dt²)=−K×x. The mass point 702 vibrates at an eigenfrequency f (frequency of pulsation generated by the pump 57) expressed as f=(½π)×(K/m)^{1/2}.

If the virtual piston is displaced by a distance x and the volume V of the volume portion 71 is changed by ΔV, the amount of change ΔV is expressed as ΔV=A×x. Furthermore, the amount of change ΔP in the pressure of the volume portion 71 when the volume V is changed by ΔV is expressed as ΔP=−k×ΔV=−k×A×x/V, where k is the modulus of volume elasticity. The modulus of volume elasticity k can be expressed as k=ρ×C² by solving the definition equation of sound speed for k. On the other hand, the equation of motion of the model of FIG. 4 described above can be expressed as M×(d²x/dt²)=ΔP×A. Substituting the M and ΔP described above into the equation and erasing k results in ρ×L₀×A×(d²x/dt²)=−ρ×C²×(A²/V)×x. Comparing this equation with the equation of motion, the spring constant K is expressed as K=ρ×C²×(A²/V). Thus, in the Helmholtz type damper 7, the values of A, L₀, and V (i.e., D and L) are set so that the pulsation reduction center frequency f₀ matches the frequency f of pulsation by the pump 57. The damper 7 reduces the pulsation of the fluid pressure by causing the brake fluid in the neck portion 72 to resonate by the pulsation of the brake fluid. The damper 7 is a damper that uses the principle of Helmholtz resonance.

Here, the configuration of the damper 7 in the housing 10 will be further described. In the description, the surface of the housing 10 where the WC ports P1, P2, P4, and P5 are opened is defined as the surface on the upper side (upper side in the vehicle installed state). As shown in FIGS. 5 to 7, the housing 10 according to the first embodiment has a rectangular parallelepiped shape as a whole, and includes a first surface (hereinafter referred to as “upper surface”) 10a where the WC ports P1, P2, P4, and P5 are formed, a second surface (hereinafter referred to as “left side surface”) 10b where the damper hole 7a of the first piping system 50a is formed, a third surface (hereinafter referred to as “front surface”) 10c where the pump 57 is disposed at the center portion, a fourth surface (hereinafter referred to as the “right side surface”) 10d where the damper hole 7a of the second piping system 50b is formed facing away from the left side surface 10b, a fifth surface (hereinafter referred to as “lower surface”) 10e facing away from the upper surface 10a, and a sixth surface (hereinafter referred to as “rear surface”) 10f where the motor 8 is disposed facing away from the front surface 10c. The pressure regulating reservoir 56 is provided on the lower surface 10e side. Thus, the housing 10 includes the upper surface 10a, the lower surface 10e, and the plurality of side surfaces 10b to 10d and 10f. The front surface 10c has a central portion (101) projecting out to accommodate the pump 57. Furthermore, the rear surface 10f has a portion where the motor 8 is installed formed to a concave shape. FIG. 2 is a conceptual view of the housing 10 viewed from the front side, and FIG. 3 is a conceptual view of the housing 10 viewed from the upper side.

As shown in FIG. 6, the motor 8 is disposed at the center portion of the rear surface 10f of the housing 10. An output shaft 81 of the motor 8 extends in the housing 10 in a direction orthogonal to the rear surface 10f and the front surface 10c. The output shaft 81 of the motor 8 is connected to a gear in the pump 57. The pump 57 is driven by the rotation of the output shaft 81. The pump 57 is disposed in the pump hole 57z in which the gear and the output shaft 81 are disposed. The pump hole 57z is opened to the rear surface 10f. Note that a substrate (not shown) and an ECU cover (not shown) of the brake ECU 6 are installed on the front surface 10c so as to cover the projecting portion 101 by the arrangement of the pump 57. The “center portion of the housing 10” corresponds to the position of the projecting portion 101 in the front surface 10c and the rear surface 10f.

The discharge flow channel C1 extend in a direction orthogonal to the axial direction of the output shaft 81 of the motor 8, and so that a virtual straight line Y extending in the extending direction of the discharge flow channel C1 and the left side surface 10b (and the right side surface 10d) extend orthogonal to each other in the discharge flow channel C1. The extending direction of the discharge flow channel C1 can also be said to be the discharging direction of the discharge valve 57a. The damper hole 7a of the first piping system 50a is formed at a position where the virtual straight line Y and the left side surface 10b intersect in the left side surface 10b, and the damper hole 7a of the second piping system 50b is formed at a position where the virtual straight line Y and the right side surface 10d intersect in the right side surface 10d. Thus, the housing 10 is formed with the damper hole 7a having an opening at a position where the virtual straight line Y and the surfaces 10b, 10d intersect in the surfaces 10b and 10d.

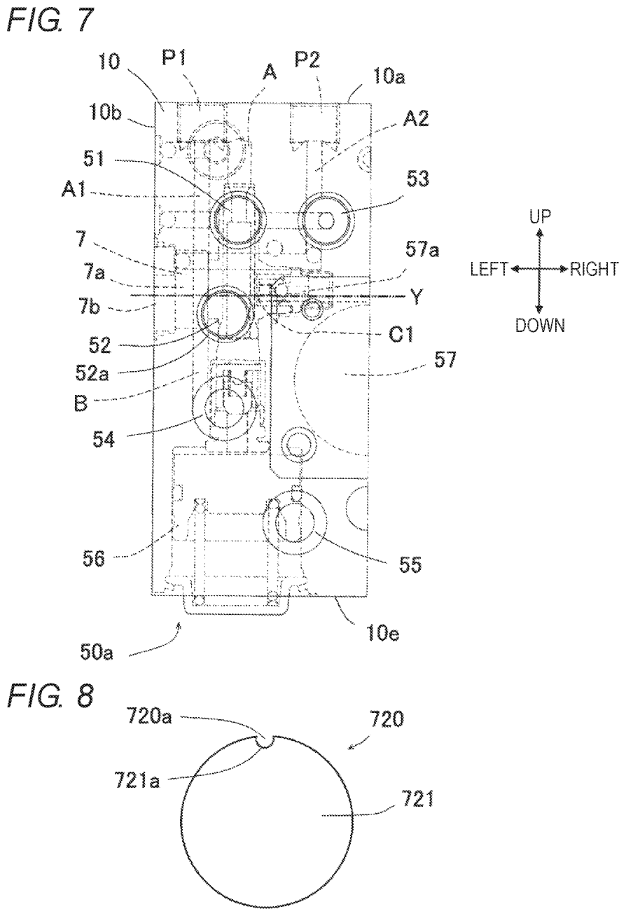

As shown in FIG. 7, the pressure increasing valve 52, a part of the main flow channel A (portion including the flow channel A1), and the like are arranged between the discharge valve 57a on the first piping system 50a side and the left side surface 10b. The pressure increasing valve 52 is disposed in a hole 52a provided from the front surface 10c toward the rear surface 10f. The main flow channel A extends from the MC port P3 provided on the rear surface 10f side to the WC port P1 through the differential pressure control valve 51, the damper 7, and the pressure increasing valve 52. The main flow channel A located around the damper hole 7a extends in a direction orthogonal to the virtual straight line Y and in a direction orthogonal to the upper surface 10a and the lower surface 10e. In FIGS. 5 to 7, some flow channels, components, and holes for accommodating the components in the housing 10 are shown.

Here, the damper hole 7a of the first embodiment is formed so that the diameter D is greater than or equal to twice the depth L (D/L≥2). The relationship between the diameter D and the depth L is a dimensional relationship suitable for reducing the pulsation of the pump 57 in the limited space in the housing 10 where the flow channel (pipe) and the solenoid valves are complicated as described above. That is, the relationship of D/L≥2 is a suitable relationship for suppressing the pulsation of the pump 57 in a relatively wide high frequency band without changing the size in the actuator 5 including the housing 10. In particular, D/L≥2 is suitable in terms of the configuration in which the damper 7 is formed using a part of the hole 10z, which is an accommodating hole of the discharge valve 57a, as the damper hole 7a while avoiding interference with components (main flow channel A, differential pressure control valve 51, pressure increasing valve 52, and pressure decreasing valve 54) close to side surfaces 10b and 10d of the housing 10. In FIGS. 6 and 7, the neck portion 72 and the diaphragm 73 are omitted. FIG. 7 shows only the first piping system 50a side.

According to the hydraulic braking device of the first embodiment, a Helmholtz type damper is applied as a damper for the pump 57, and the high frequency pulsation of the pump 57 can be reduced without increasing the size of the housing 10 by utilizing the principle of Helmholtz resonance. In particular, in the actuator 5 capable of exhibiting the skid prevention function, since the damper 7 is connected to a portion between the differential pressure control valve 51 and the pressure increasing valves 52 and 53 in the main flow channel A or the discharge flow channel C1, the pulsation of the pump 57 can be reduced directly and effectively.

Furthermore, the damper 7 is disposed in the damper hole 7a provided on the side surface of the housing 10 (here, the left side surface 10b and the right side surface 10d). The damper hole 7a is provided on the extended line (on the virtual straight line Y) of the discharge flow channel C1, and the discharge flow channel C1, that is, the hole 10z into which the discharge valve 57a is inserted can be used for the formation. That is, according to this configuration, the space in the housing 10 can be used effectively, and the manufacturing process can be prevented from becoming complicated. As described above, according to the first embodiment, it is possible to reduce the number of times to for, holes in the housing 10 and to achieve an efficient layout. In this configuration, the discharge flow channel C1 is extended in a direction orthogonal to the output shaft 81 of the motor 8.

Furthermore, in the first embodiment, since the discharge flow channel C1 is provided so that the virtual straight line Y and the left side surface 10b and the right side surface 10d are orthogonal to each other, the damper hole 7a is formed in a direction orthogonal to the left side surface 10b and the right side surface 10d, and the flow channels and components can be arranged in the housing 10 in a space-efficient manner. In other words, according to such a configuration, an efficient layout is achieved that does not interfere with other configuring members and that utilizes dead space. Furthermore, as described above, the volume portion 71 is preferably formed so that the diameter D is greater than or equal to twice the depth L due to the space constraints. Moreover, the pulsation reducing effect and the durability improving effect are further exhibited by arranging the diaphragm 73 in the volume portion 71. In the first embodiment, it is more effective as a plurality of diaphragms 73 are arranged.

In the first embodiment, an orifice plate is used as the neck portion 72, so that the neck portion 27 can be arranged, manufactured, and dimension designed relatively easily. In the configuration in which the opening of the damper hole 7a is provided on the surface of the housing 10, the damper hole 7a is likely to become deep, and it becomes difficult to provide the neck portion 72 by processing (cutting or the like) in the damper hole 7a. However, according to the first embodiment, in forming the neck portion 72 in the housing 10, it is only necessary to arrange (fix) the orifice plate (72) in the damper hole 7a, and the manufacturing of the damper 7 is facilitated. Furthermore, the frequency band to be reduced by the principle of Helmholtz resonance can be adjusted by designing the opening area and the axial length of the orifice hole 72a, and the frequency to be reduced can be easily adjusted or changed. Moreover, according to the present configuration, since it can respond to a different frequency band according to a vehicle model, for example, the components can be shared and it can contribute to the enhancement in productivity.

### Second Embodiment

An actuator (hydraulic braking device) according to a second embodiment is different from the first embodiment mainly in the configuration of the neck portion 72. Therefore, only different portions will be explained. In the description of the second embodiment, the descriptions and the drawing of the first embodiment can be appropriately referred to.

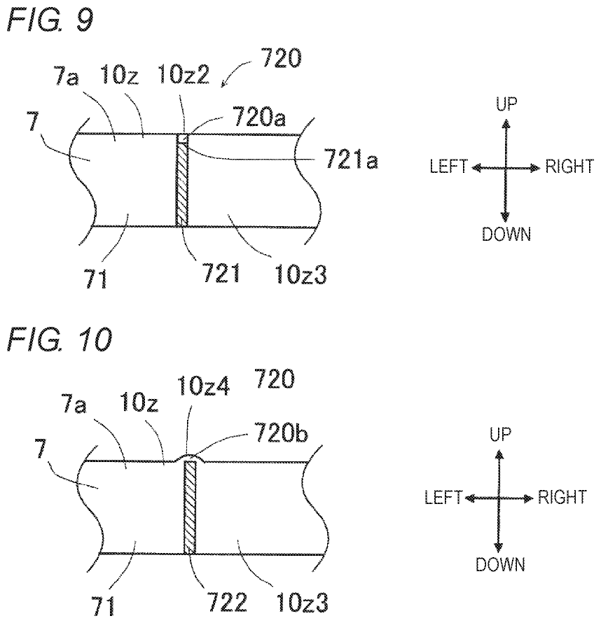

As shown in FIGS. 8 and 9, the neck portion 720 according to the second embodiment is configured by a disc-shaped orifice plate 721 in which a concave portion 721a is formed on the upper edge portion, and a wall portion 10z2 of the hole 10z (damper hole 7a) corresponding to the arrangement position of the orifice plate 721. The orifice plate 721 is formed to a shape in which a part of the outer peripheral surface is recessed toward the center side. A flow channel 720a which is an orifice hole is formed by the concave portion 721a and the wall portion 10z2. Furthermore, when a portion of the hole 10z that is a predetermined distance away from the orifice plate 721 toward the discharge flow channel C1 side is referred to as a discharge side portion 10z3, as shown in FIG. 9, the hole 10z of the second embodiment is formed such that the discharge side portion 10z3 and the volume portion 71 have the same diameter. In other words, the orifice plate 721 is disposed at a portion other than the end of a portion having a constant diameter (e.g., portion without the step 10z1) in the hole 10z. The hole 10z of FIG. 9 has a constant diameter in a predetermined range before and after in the flow direction of the neck portion 720. The neck portion 720 is configured such that the volume portion 71 and the discharge side portion 10z3 communicate with each other only by the flow channel 720a. That is, the outer peripheral surface of the orifice plate 721 other than the concave portion 721a and the wall surface of the hole 10z are in contact with each other.

According to such a configuration, the flow channel 720a functions as an orifice hole, and effects similar to the first embodiment are exhibited. Furthermore, since the flow channel 720a is formed at the upper end position of the internal space of the hole 10z, it is possible to suppress the occurrence of air remaining in the volume portion 71 in the air venting operation. In the configuration of the second embodiment, the flow channel 720a merely needs to be formed at the upper end of the neck portion 720, and the diameter of the volume portion 71 and the discharge side portion 10z3 may not be the same. The configuration around the neck portion 720 may be a configuration in which, for example, the diameter of the discharge side portion 10z3 decreases (or increases) gradually or in a step-like manner from the neck portion 720 on the assumption that the flow channel 720a is secured. Furthermore, the predetermined distance of the discharge side portion 10z3 can be set to, for example a distance to the discharge valve 57a. Furthermore, the orientation in which the orifice plate 721 is attached may be appropriately changed according to the actual orientation of vehicle attachment. With the configuration of the second embodiment described above, the orientation of the orifice plate 721 (position of orifice hole) can be appropriately changed according to the vehicle model, so that the components can be shared.

As a modified example of the second embodiment, for example, as shown in FIG. 10, a neck portion 720 may be configured by a disc-shaped orifice plate 722 without any holes or concave portions, and a concave portion (recess) 10z4 provided at the upper wall of the hole 10z (damper hole 7a). The concave portion 10z4 is provided above the orifice plate 722, and forms a flow channel 720b corresponding to the orifice hole with the outer peripheral surface of the upper part of the orifice plate 722. The neck portion 720 is configured such that the volume portion 71 and the discharge side portion 10z3 communicate with each other only by the flow channel 720b. That is, the outer peripheral surface of the orifice plate 722 and the wall surface of the hole 10z other than the concave portion 10z4 facing thereto are in contact with each other.

Similar effects as described above are also exhibited by such configuration. Furthermore, according to the modified example, when arranging the orifice plate 722 in the hole 10z, there is no need to worry about the orientation (up and down) of the orifice plate 722, and workability is improved. In the modified example as well, as described above, the diameter of the volume portion 71 and the discharge side portion 10z3 (portion excluding the concave portion 10z4) may not be the same. In the first and second embodiments, it can be said that the neck portions 72 and 720 are configured by the orifice plates 72, 721, and 722 that form the orifice holes 72a, 720a, and 720b.

### <Others>

The present invention is not limited to the embodiment described above. For example, the damper hole 7a may be provided on a different surface other than the left side surface 10b and the right side surface 10d of the housing 10. However, the damper hole 7a is preferably provided on a surface other than the surface where the WC ports P1, P2, P4, and P5 are provided in the housing 10 in terms of the arrangement space. Furthermore, the damper 7 may be connected to another flow channel in the housing 10. The number of diaphragms 73 may be one or may not be provided. Furthermore, the diaphragm 73 is not limited to a wave shape. The pump 57 is not limited to a gear pump, and for example, may be a piston pump. For example, in a flow channel to which a plurality of piston pumps are connected, the pulsation caused by the plurality of pumps is considered to be a high frequency, and in particular, the application of the present configuration is particularly effective with respect to a configuration with three or more, and furthermore six or more piston pumps. Moreover, the present invention may be applied to a brake device of a type in which the master cylinder 230 is not arranged. The present invention can also be applied to an autonomous vehicle. The type of piping may be X piping or front/back piping. The damper hole 7a can also be said to be a cylindrical portion of the housing 10 that defines the internal space. The damper hole 7a can be defined as a portion from the opening (surface of the housing 10) to the arrangement positions of the orifice plates 72, 721, and 722. Furthermore, in the embodiment described above, the volume portion 71 is formed so that the diameter has a length of greater than or equal to twice the depth.

1. A hydraulic braking device comprising: a housing; a pump disposed in the housing; a motor for driving the pump; a plurality of solenoid valves disposed in the housing; a wheel cylinder port provided in the housing and connected to a wheel cylinder; and a flow channel provided in the housing to connect the pump, the plurality of solenoid valves, and the wheel cylinder port,
the motor and the plurality of solenoid valves being controlled to generate fluid pressure in the wheel cylinder,
the hydraulic braking device comprising:
a Helmholtz type damper disposed in the housing and connected to the flow channel to reduce pulsation generated by driving of the pump using a principle of Helmholtz resonance.

2. The hydraulic braking device according to claim 1, further comprising:
a master cylinder port provided in the housing and connected to a master cylinder, and a reservoir disposed in the housing,
wherein
the flow channel includes a main flow channel that connects the wheel cylinder port and the master cylinder port, a pressure decreasing flow channel that connects the wheel cylinder port and the reservoir, and a discharge flow channel that connects a discharge valve of the pump and a connecting portion on the main flow channel;
the plurality of solenoid valves include a differential pressure control valve disposed at a portion between the connecting portion and the master cylinder port in the main flow channel, a pressure increasing valve disposed at a portion between the connecting portion and the wheel cylinder port in the main flow channel, and a pressure decreasing valve disposed in the pressure decreasing flow channel; and
the Helmholtz type damper is connected to a portion between the differential pressure control valve and the pressure increasing valve in the main flow channel or the discharge flow channel.

3. The hydraulic braking device according to claim 2, wherein
the motor is disposed at a center portion of the housing;
the discharge flow channel extends in a direction orthogonal to an axial direction of an output shaft of the motor;
the housing is formed with a damper hole having an opening at a position where a virtual straight line extending in an extending direction of the discharge flow channel and a surface intersect in the discharge flow channel in the surface of the housing; and
the Helmholtz type damper is disposed in the damper hole.

4. The hydraulic braking device according to claim 2, wherein
the pump is a gear pump configured such that a gear is disposed together with the motor at a center portion of the housing;
the wheel cylinder port is formed on a first surface of the housing;
the discharge flow channel is extended in a direction orthogonal to an axial direction of an output shaft of the motor and in which a virtual straight line extending in an extending direction of the discharge flow channel and a second surface of the housing are orthogonal to each other in the discharge flow channel;
the housing is formed with a damper hole having an opening at a position where the virtual straight line and the second surface intersect in the second surface; and
the Helmholtz type damper is disposed in the damper hole.

5. The hydraulic braking device according to claim 4, wherein the damper hole is formed so that a diameter has a length greater than or equal to twice a depth.

6. The hydraulic braking device according to claim 1, wherein the Helmholtz type damper includes a metal diaphragm in which a gas is sealed inside as a pulsation reducing mechanism.

7. The hydraulic braking device according to claim 3, wherein
the Helmholtz type damper includes a volume portion, and a neck portion connected to the volume portion to function as an orifice;
the neck portion is formed by an orifice plate that forms an orifice hole; and
the orifice plate is disposed in the damper hole.

8. The hydraulic braking device according to claim 4, wherein
the Helmholtz type damper includes a volume portion, and a neck portion connected to the volume portion to function as an orifice;
the neck portion is formed by an orifice plate that forms an orifice hole; and
the orifice plate is disposed in the damper hole.

9. The hydraulic braking device according to claim 5, wherein
the Helmholtz type damper includes a volume portion, and a neck portion connected to the volume portion to function as an orifice;
the neck portion is formed by an orifice plate that forms an orifice hole; and
the orifice plate is disposed in the damper hole.
